(19) United States
(12) Patent Application Publication
(10) Pub. No.: US 2016/0340065 A1
(43) Pub. Date: Nov. 24, 2016

(54) APPARATUS AND METHOD FOR PRECISE COFFEE BEAN DISPENSING

(71) Applicants: Douglas Joseph Weber, San Francisco, CA (US); Craig Robert Lyn, Los Angeles, CA (US)

(72) Inventors: Douglas Joseph Weber, San Francisco, CA (US); Craig Robert Lyn, Los Angeles, CA (US)

(73) Assignee: Strategic Exits LLC, Los Angeles, CA (US)

(21) Appl. No.: 15/087,893

(22) Filed: Mar. 31, 2016

Related U.S. Application Data
(63) Continuation of application No. 62/163,215, filed on May 18, 2015.

(51) Int. Cl. B65B 1/32; A47J 42/40; A47J 42/44; A47J 31/40; A47J 31/42

(52) U.S. Cl. CPC B65B 1/32; A47J 31/40; A47J 31/42; A47J 42/44; A47J 42/40

(57) ABSTRACT

A device for precise dispensation of whole coffee beans. The device may consist of a coffee bean hopper attached to an incremental dispensation device such as a toothed gear rotated by a stepper motor, whereby the rotation of the gear precisely dispenses whole coffee beans into a receptacle mounted upon a load cell or other weighing device. As the beans are dispensed into the receptacle, a PCB or other electronic component controls a feedback loop from the weighing device to the motor such that the dispensed amount is within +/−one coffee bean in weight. The desired weight may be input via buttons attached to the PCB with a readout that allows 0.1 g accuracy, or roughly the weight of one coffee bean.

### FIELD OF THE INVENTION

The present disclosure relates to precise coffee bean dispensation and, more particularly, to a countertop coffee bean dispensation apparatus and method.

### BACKGROUND

Sophistication in the process of making coffee beverages has increased significantly in recent years. One such area of sophistication is the measurement of coffee before preparing a coffee drink. Preparation of a single serving of coffee has become much more popular lately, both at home and in a café, for a variety of brewing techniques (e.g., pour-over, French press, espresso, aeropress, etc.). For a single serving it becomes more important to provide a precise amount of coffee for preparing the drink. For example, in a café the barista will often precisely weigh the amount of coffee to be employed in making a coffee drink at a scale, manually adding and subtracting either beans or grinds until exactly the desired amount is provided. Often the level of precision desired in the measurement is ±0.1 g.

Such a process can be tedious and costly. Accordingly, there is a need for a more convenient manner of delivering a precise dose of coffee prior to preparing a coffee drink.

### SUMMARY

In accordance with embodiments disclosed herein, a coffee bean dispensing apparatus includes a closed loop system between a bean delivery device (e.g., a stepper motor driven gear wheel, a conveyor belt or a vibration table) and a weighing device positioned to weigh coffee beans delivered to a receptacle. It will be understood that while the term “weighing device” is used herein, the device may actually measure mass rather than weight. The weighing device provides feedback to the bean delivery mechanism (e.g., via a controller) to ensure that the delivery is stopped when a preset weight or mass of coffee beans for a desired dose is delivered to the receptacle.

In some embodiments, the bean delivery device is configured to deliver coffee beans with single-bean precision. For example, in one embodiment, the bean delivery device includes a toothed gear where the teeth are separated by a distance that accommodates one coffee bean, and walls on either side of the toothed gear can define a channel of a width also selected to accommodate one bean. A gate (e.g., a spring-loaded flap) is positioned adjacent to the gear to prevent the passage of beans from a storage area (e.g., bean hopper) upstream of the device to the receptacle in the absence of positive drive from a motor rotating the gear. Accordingly, only a single bean can pass from the upstream storage to the apparatus receptacle at one time. The motor drives a stream of beans that is only one bean in height and width (or cross section of the bean path), and can be stopped by a controller in response to the feedback loop indicating that the desired mass or weight has been reached. In another embodiment, the bean delivery device can include a conveyor belt. The conveyor belt can include features to limit the delivery to a single bean at a time, such as features defining a bean-sized pocket (e.g., teeth) and a scraping or gating mechanism (such as a spring-loaded flap), along with a channel with a limited width transverse to the direction of belt travel, to allow delivery of coffee beans with single-bean precision. In another embodiment, the bean delivery device can include a vibrating table with a slight slope, with a funnel that allows only one bean to pass at a time from the upstream storage to the apparatus receptacle.

In some embodiments, the bean delivery device is configured for multi-mode or multi-step dispensation. In a first mode, the apparatus operates in a rapid initial dispensing mode, and in a second mode, the apparatus operates in a slower or more controlled subsequent dispensing mode as the target weight or mass is approached, allowing for single-bean precision without overshoot, while at the same time providing faster overall delivery. Illustrated embodiments have two modes, but the skilled artisan will appreciate that 3 or more modes can be provided. In one embodiment, the bean delivery device includes a dual speed motor. In a first mode, the apparatus operates at a relatively fast speed of dispensation that may risk overshoot if continued to the target weight or mass. However, feedback from the weighing device to a controller instructs the motor to step down to a lower speed for the second mode, when the target weight or mass is approached, to avoid overshoot. At the lower speed, the feedback from the weighing device has precise enough control over the delivery to stop the delivery mechanism with single-bean (or about 0.1 g) precision. For different types of coffee, a single bean may represent an average of 0.08 g to about 0.13 g. In another embodiment, the bean delivery device includes two or more delivery mechanisms. At least one mechanism provides gross dispensation for faster delivery, and at least one mechanism provides finer control for the feedback to allow for single-bean (or about 0.1 g) precision. In an illustrated example, the teeth pitch on two different gear mechanisms through which the beans pass en route to the apparatus receptacle can be different for the gross dispensation delivery mechanism and the fine-control mode. The gross dispensation mechanism might allow multiple beans to pass to the apparatus receptacle at one time, while the fine control mechanism allows only a single bean to pass at one time. In the first mode, either only the gross dispensation mechanism is operated, or both the gross dispensation and the fine control mechanisms are operated together. In the second mode, only the fine control mechanism is operated. In still another embodiment, multiple different delivery modes can employ multiple different dispensation mechanisms and speeds.

In operation, the user inputs a desired weight or mass at a user interface of the apparatus. In some embodiments, the user then starts the machine with an input device (e.g., button), upon which the machine automatically dispenses beans into an apparatus receptacle until the target weight is achieved to within ±one bean, or about ±0.1 g, at which point the machine stops dispensing and displays the weight or mass of the total beans dispensed. The user can then manually dump from the apparatus receptacle into a separate receptacle for immediate use or sealing and storage or the apparatus can automatically perform one or both of dumping and sealing a separate downstream receptacle.

### BRIEF DESCRIPTION OF THE DRAWINGS

FIG. 1 is a front and left isometric view of a counter-top coffee bean dispensing apparatus in accordance with an embodiment, with some components shown transparent or omitted for purposes of illustration.

FIG. 2 is a schematic cross section of a bean delivery device (e.g., toothed gear and spring-loaded flap), apparatus receptacle (e.g., weigh chamber) and a weighing mechanism (e.g., load cell) in accordance with the embodiment of FIG. 1.

FIG. 3 is a back and right side isometric view of the apparatus of FIG. 1 with the right leg and some other components shown transparent or omitted for purposes of illustration.

FIG. 4 is a front and right side isometric view of a counter-top coffee bean dispensation apparatus in accordance with an embodiment, with some components shown transparent or omitted for purposes of illustration, showing emptying of the weigh chamber into a downstream receptacle (e.g., for storage, transportation and/or grinding) after a precise batch of beans has been dispensed by desired weight into the weigh chamber.

FIG. 5 is a schematic cross section of the embodiment of FIG. 1, showing a load cell under the weigh chamber.

FIG. 6 is a schematic cross section of another embodiment with a weighing mechanism (e.g., defection plate) between the bean dispensing mechanism and the receptacle.

FIG. 7 is a front and left isometric view of a counter-top coffee bean dispensing apparatus in accordance with another embodiment, where the bean delivery device comprises a toothed conveyor belt and a scraping plate or spring-loaded flap.

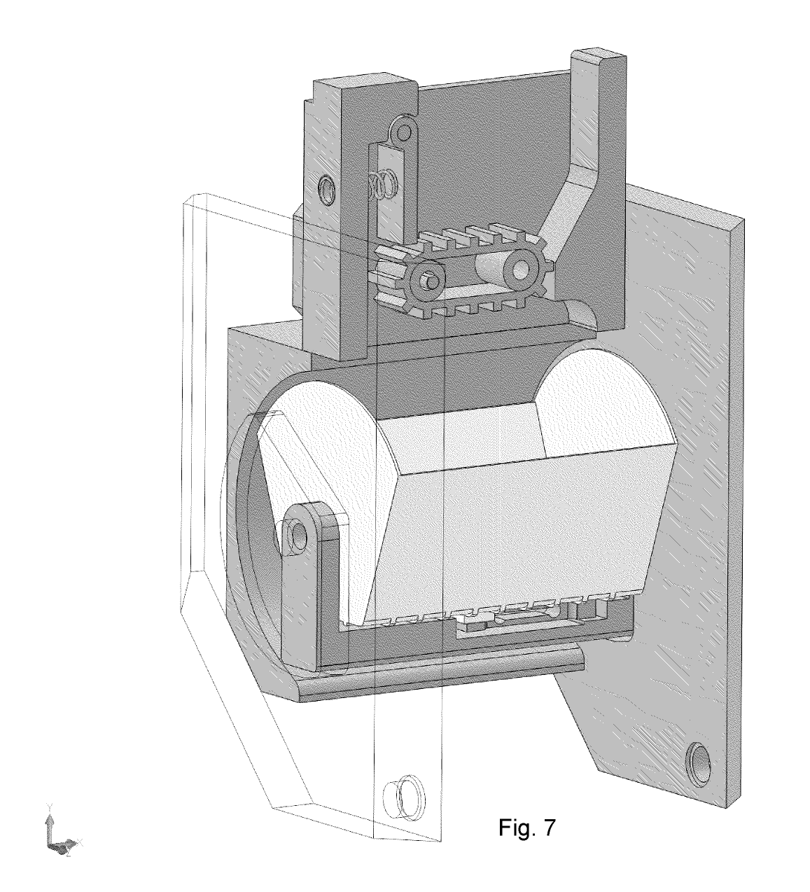

FIG. 8 is schematic cross section of the apparatus of FIG. 7.

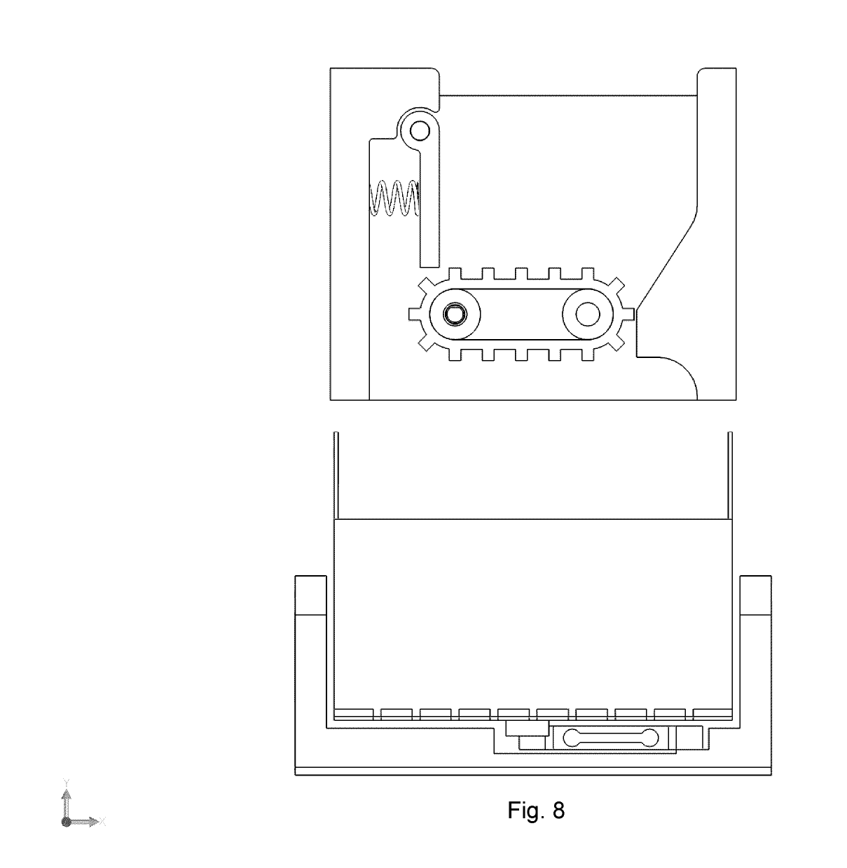

FIG. 9 is a schematic cross section of a bean delivery device employing two motor speeds for fast initial delivery and slower speeds when approaching the target weight or mass.

FIG. 10 is a schematic cross section of a dual bean delivery device, employing one delivery mechanism for fast initial dispensing and another delivery mechanism for fine granular control when approaching the target weight or mass. In the illustrated example, the pitch or space between teeth on a gear mechanism differs for fast vs. greater controlled dispensing.

### DESCRIPTION OF EMBODIMENTS

In general, the present disclosure relates to a precise and accurate countertop coffee bean weighing and dispensation system that quickly and efficiently outputs a precise dose of coffee beans by weight or mass, and obviates manually weighing and adjusting the amount of coffee beans before grinding and brewing.

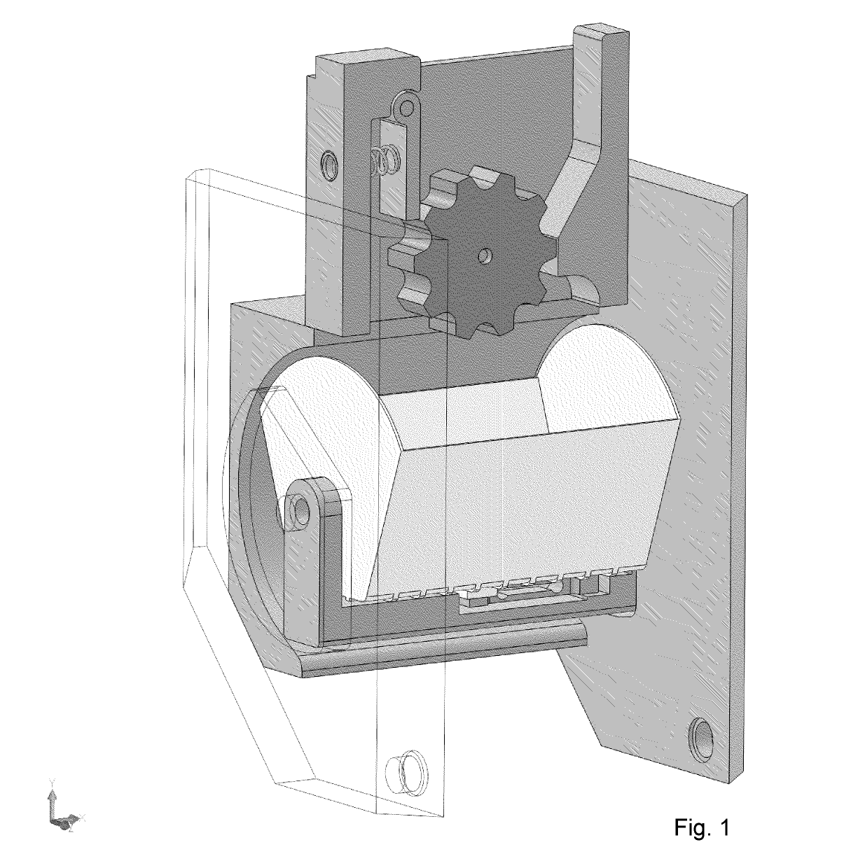

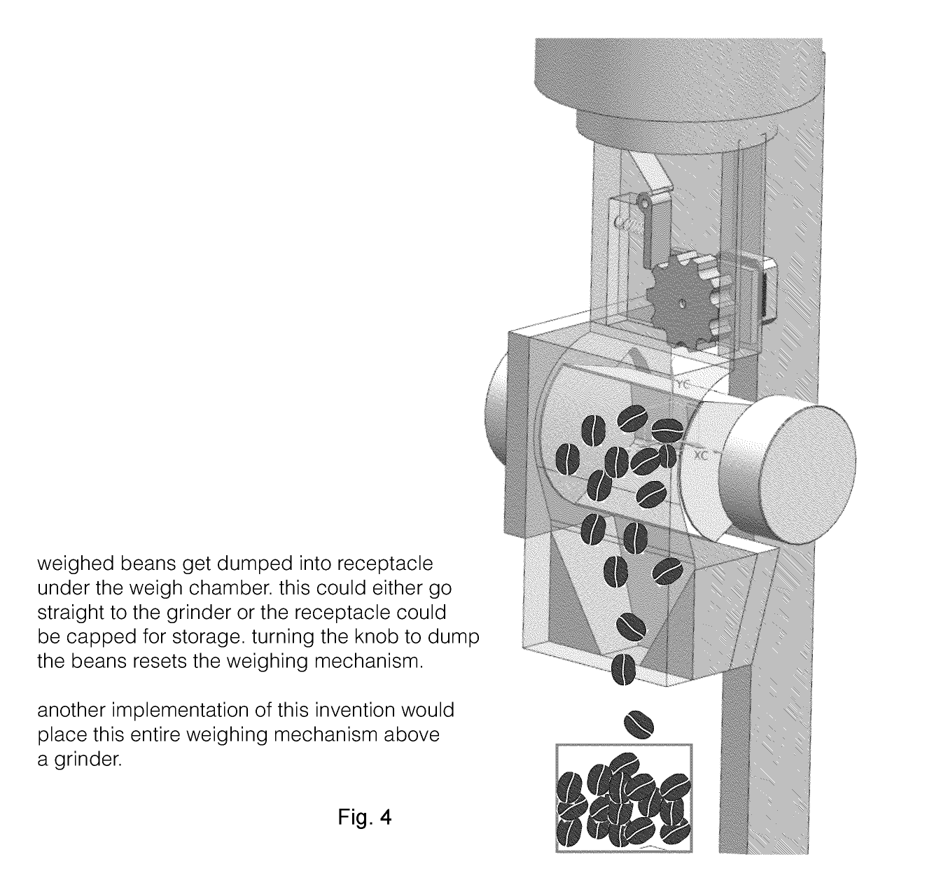

FIGS. 1-5 illustrate an embodiment of a coffee bean dispensing apparatus with a bean delivery device (in the form of a toothed gear) and a gate (in the form of a spring-loaded flap) that serves to control passage of coffee beans in the absence of positive drive from the bean delivery device. In some embodiments the spring-loaded flap can also serve as a counter. The illustrated apparatus additionally comprises an upstream bean storage in the form of a bean hopper; a stepper motor; at least one dispense knob (one shown on either side); an apparatus bean receptacle in the form of a “weigh chamber,” a weighing or mass measurement device in the form of a load cell; a downstream receptacle for receiving beans from the apparatus receptacle (this may be a consumable item); a user interface including user interface inputs (e.g., buttons and/or dials); and a printed circuit board (PCB) with a processor and memory that serves as a controller. In some embodiments, the coffee bean dispensing apparatus is hermetically-sealed. For the illustrated countertop embodiments, the hopper can be sized to hold between 0.1 lb. and 2.5 lbs of beans, while the apparatus receptacle can be sized to hold between 0.1 g and 60 g. of coffee beans (typically representing about 1 to 60 beans). Hermetic sealing can include use of an inert gas to displace any oxygen in the receptable after filling with the dose of beans.

High precision, preferably to the single-bean level of precision (e.g., 0.8 g to 0.13 g, depending on the bean size), can be achieved by selection of the pitch and space between teeth such that the combination of the gear rotation and spring-loaded flap permits only one bean to pass to the apparatus receptacle at a time. In other embodiments, single-bean precision in dispensing a dose by weight or mass can be facilitated by bean delivery devices pockets or slots on conveying mechanisms other than the illustrated bean wheel or gear, such as conveyor belts or auger conveyors, together with a scraping plate or spring-loaded flap. The user interface includes input devices (buttons, dials, etc.) that permit the user to select a desired dose by weight or mass. The above conveying mechanisms or others (e.g., vibration table) can also be employed with a funnel to ensure a single-bean stream that can be halted by the feedback signals from the weighing device or mass measurement.

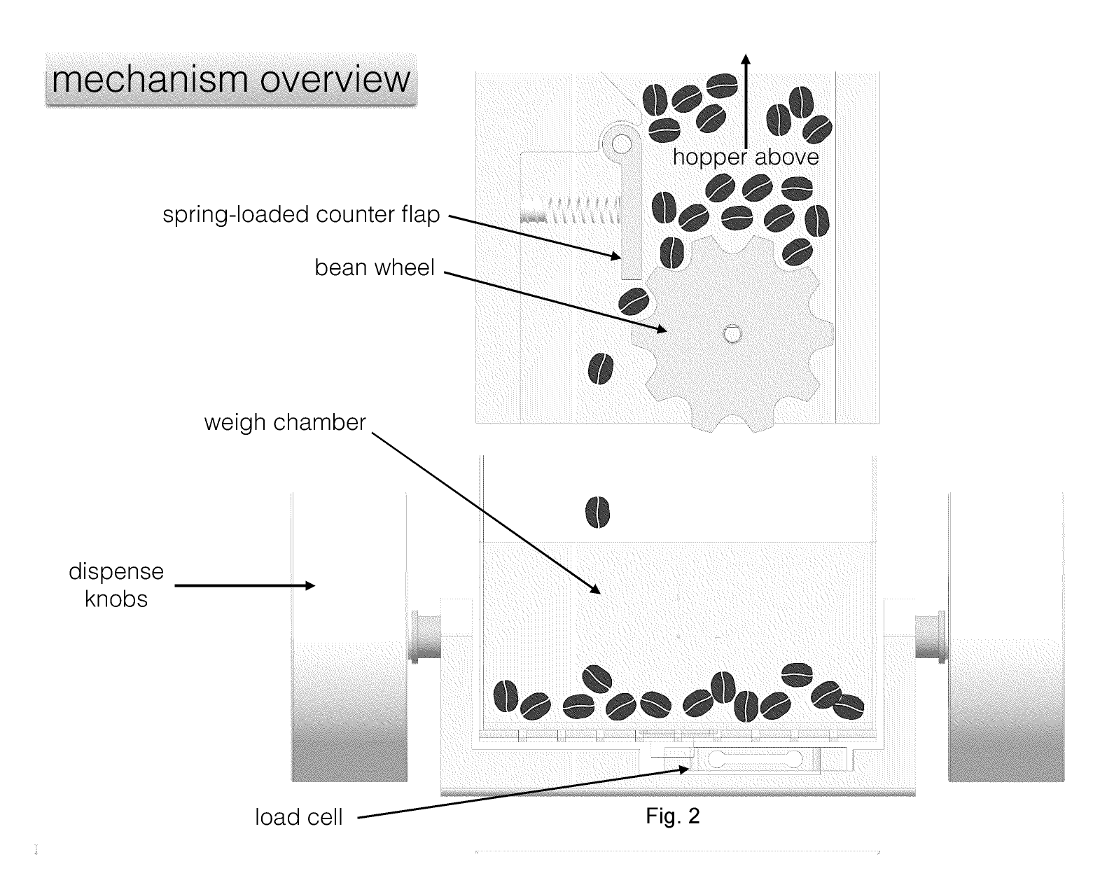

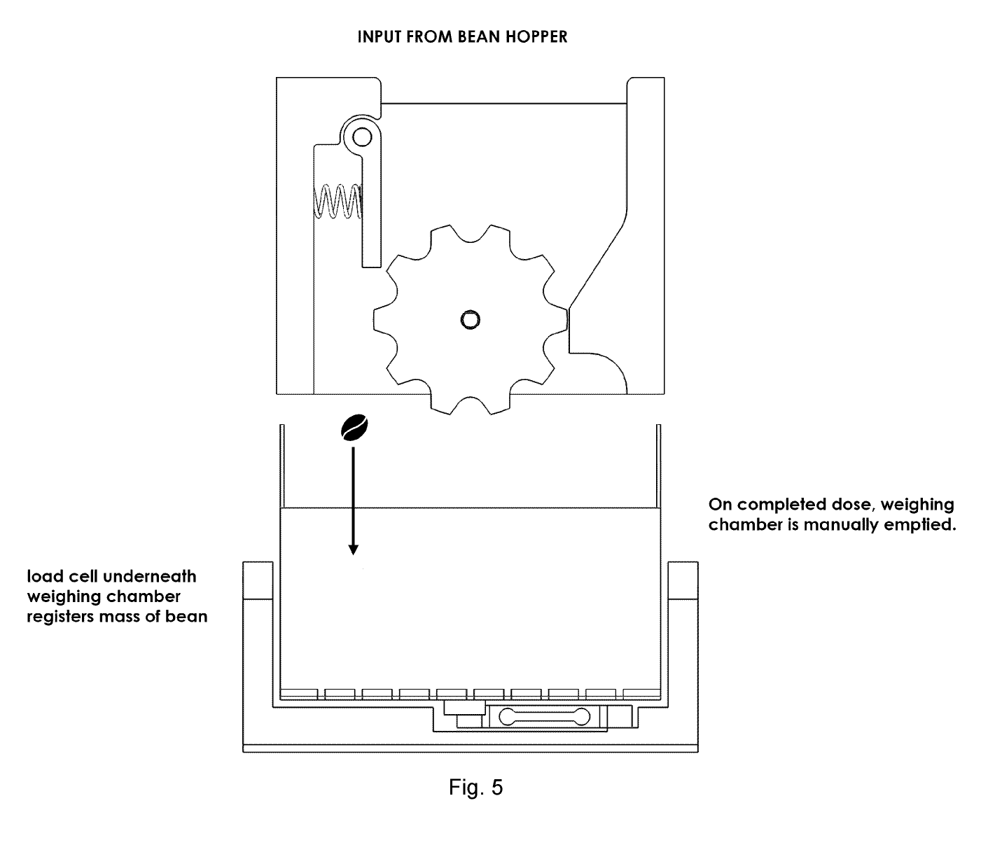

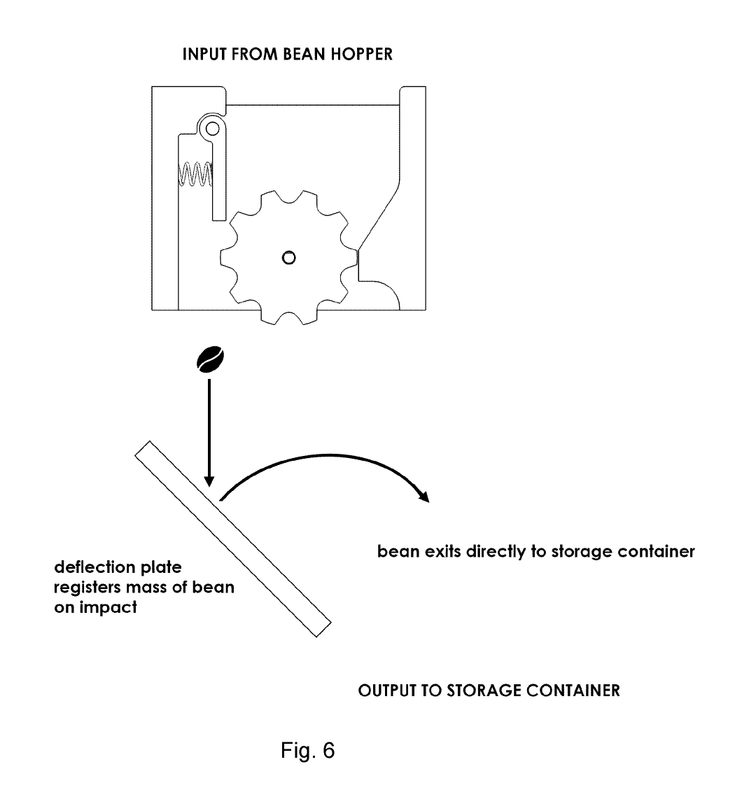

The weighing device shown in FIGS. 2 and 5 is a load cell. In other embodiments, the weighing (or mass measuring) device can comprise a strain gauge, a deflection plate (see FIG. 6), a spring scale or a scale employing counterweights. While FIGS. 2 and 5 show the weighing device under the apparatus receptacle (e.g., weigh chamber), in other arrangements the weighing device may be positioned between the bean delivery mechanism (e.g. gear and flap) and the apparatus receptacle, as in the embodiment of FIG. 6.

To further facilitate accurate dose delivery with single-bean precision, without unduly slow operation, the bean delivery device that gates dispensation can operate in two modes. In a first (fast, rough or gross) mode, beans can be initially dispensed at a relatively fast rate. Feedback from the weighing device can indicate when the dose in the receptacle (e.g., weigh chamber) is within a threshold value of the desired dose, which can be programmed into the controller a selected level (e.g., a level within about 80-99% of the desired dose weight or mass). When the threshold is met, the controller switches the bean delivery device to a second (slow or fine) mode in which the rate of dispensation is slowed to avoid overshoot and permit greater precision and thus accuracy in the dose delivered. The skilled artisan will appreciate that the bean delivery device can employ more than two modes, or continuously variable speeds for the same purpose.

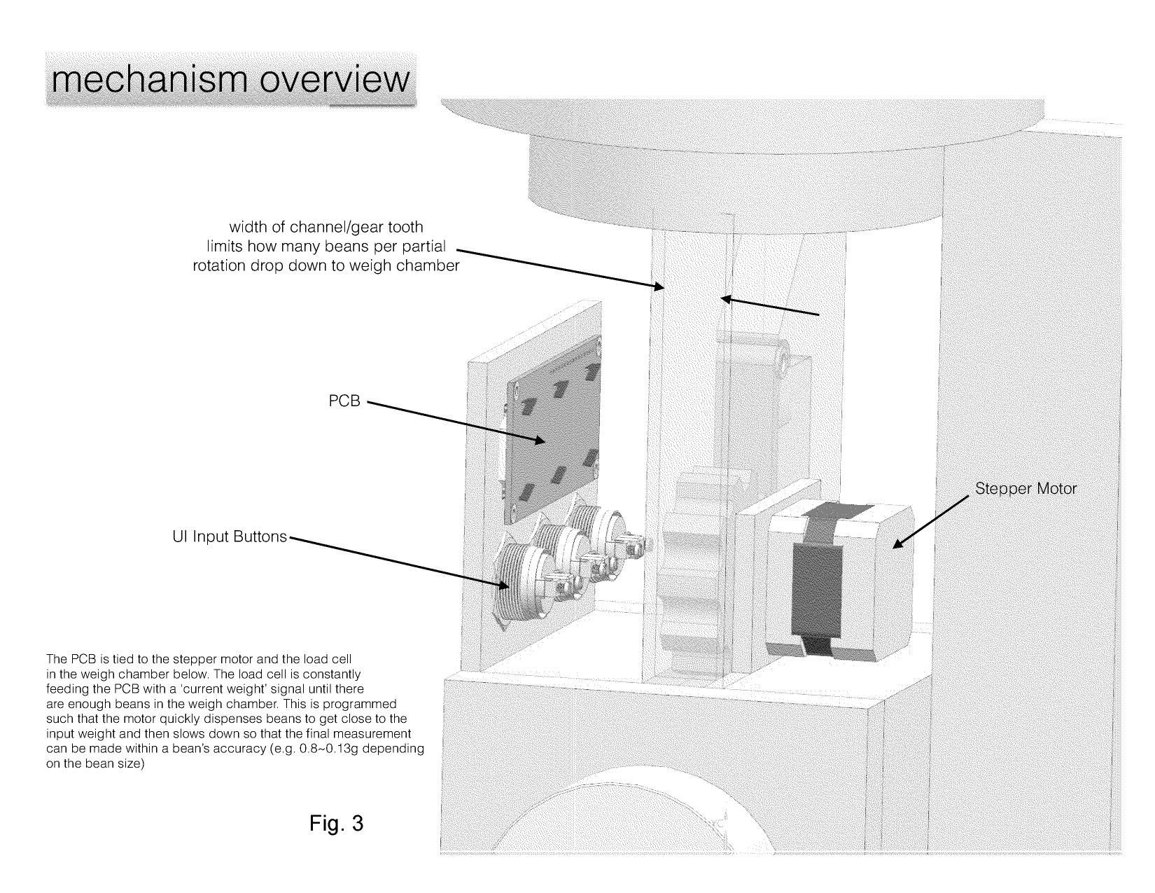

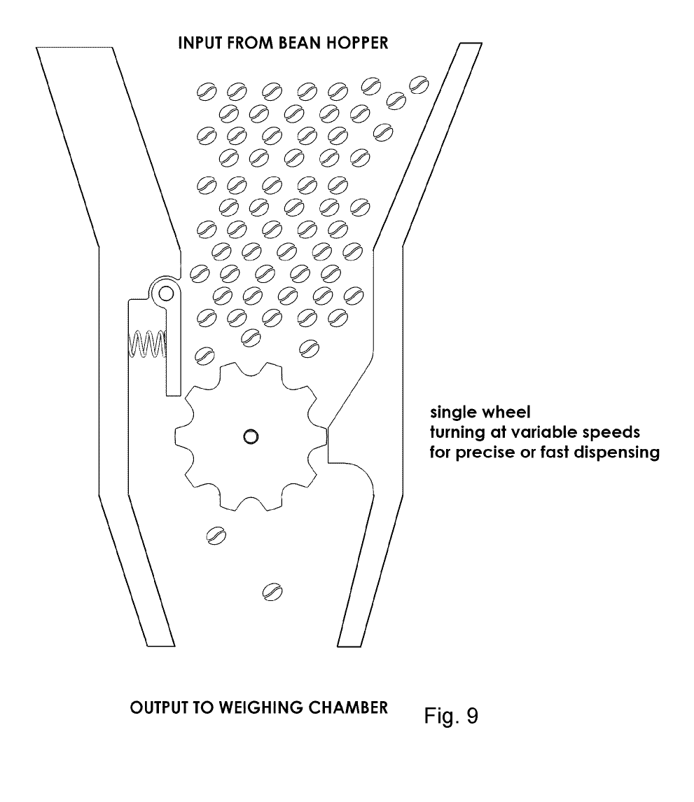

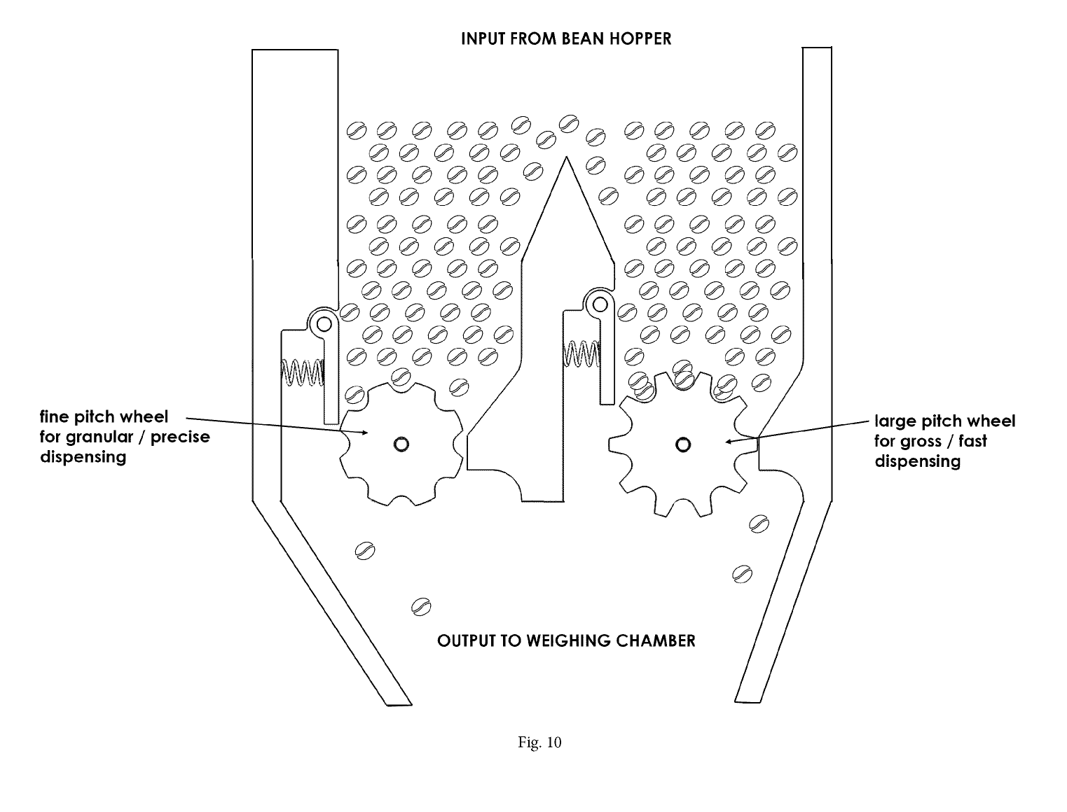

In the embodiments of FIGS. 3 and 9, the two modes can be implemented by a single bean path through the bean delivery device and a stepper motor that can slow the bean delivery device as the target dose by weight or mass is approached. In contrast, in the embodiment of FIG. 10, the bean delivery device includes two separate paths having bean conductances, or rates of delivery, to represent the modes of operation noted above. A single motor having a single operational speed can be switched between the two conveying mechanisms to achieve the two modes noted above. Of course, a combination of multiple conveying mechanisms with different conductances and multiple motor speeds can be employed in other arrangements. While illustrated with two different gears having different teeth arrangements for different conductances, the skilled artisan can readily determine, in view of the teachings herein, how to arrive at different conductances for alternative types of conveying mechanisms.

The weighing mechanism provides feedback to the controller, and once the target weight or mass is reached, the controller stops the bean delivery device and can provide the user with an indication of completion on the user interface. In the illustrated embodiment of FIG. 2, the user can manually turn the dispense knob(s) to empty the precisely measured bean dose from the apparatus receptacle (weigh chamber) to a downstream receptacle, which may be sealed to maintain freshness before subsequent grinding and preparation of a coffee beverage. Alternatively, the apparatus may be configured for automatic dumping from the apparatus receptacle (weigh chamber) to a downstream receptacle. Such a downstream receptacle may be a consumable or may be a reusuable container. Such a removable container can also be employed in place of the illustrated weigh chamber in other arrangments. In embodiments, the dose size, the size of the apparatus receptacle and the size of the container are suitable for preparation of a single serving coffee beverage. In place of a downstream receptacle, or between a downstream receptacle and the apparatus receptacle, a grinding device may be modularly or integrally incorporated into the apparatus.

In embodiments, the coffee bean dispensing apparatus can be provided with a calibration cycle. While the approximation of 0.1 g/bean is noted above, in reality different types of beans can have different average weights or masses, usually in the range of 0.8 g/bean to 1.3 g/bean. Accordingly, a calibration cycle can more accurately determine the average weight or mass per bean. Beans are placed in the bean hopper or upstream storage. The user can hit a button or other input device on the user interface to initiate calibration. Calibration cycle can have definite (e.g., 10 beans) or indefinite duration (e.g., until average bean weight or mass falls within acceptable statistical parameters). A spring-loaded flap, deflection plate or other counting device can count the number of beans dispensed, and the weighing device measures the weight or mass of the counted beans.

Such an average coffee bean weight or mass can be used to dispense target dose amounts that are input by the user by weight or mass, but without a real-time feedback loop from the weighing device. Instead, the average weight or mass is employed and the device calculates the number of beans to dispense. During dispensation of the dose, either the counting device is employed with feedback to the bean delivery device, or the device itself is operated at a known rate of bean conductance (e.g., 10 beans per revolution for the apparatus of FIG. 2) for sufficient time to deliver the calculated number of beans for the desired weight or mass, given the average weight or mass per bean determined by the calibration cycle. In this case, the weighing device provides feedback to the controller during the calibration cycle, but during operation feedback is provided by a counter (or a proxy for a counter), and the desired dose by weight is achieved by dividing the desired weight/mass by the average per bean to arrive at a desired bean count.

Various other modifications, adaptations, and alternative designs are of course possible in light of the above teachings. Therefore, it should be understood at this time that within the scope of any appended embodiments the invention may be practiced otherwise than as specifically described herein. It is contemplated that various combinations or subcombinations of the specific features and aspects of the embodiments disclosed above may be made and still fall within one or more of the inventions. Further, the disclosure herein of any particular feature, aspect, method, property, characteristic, quality, attribute, element, or the like in connection with an embodiment can be used in all other embodiments set forth herein. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above. Moreover, while the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents, and alternatives falling within the spirit and scope of the various embodiments described and the appended embodiments. Any methods disclosed herein need not be performed in the order recited. The methods disclosed herein include certain actions taken by a user; however, they can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately”, “about”, and “substantially” as used herein include the recited numbers (e.g., about 10%=10%), and also represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amoun

### VARIOUS EMBODIMENTS

1. A countertop coffee bean dispensing apparatus, comprising: a bean delivery device configured to deliver coffee beans with single-bean precision; a weighing device configured to measure weight or mass of coffee beans.

2. The apparatus of Embodiment 1, wherein the bean delivery device comprises: a toothed gear comprising a plurality of pockets each configured to accommodate and transport one coffee bean, wherein each of the plurality of pockets is formed by the distance between two adjacent teeth of the toothed gear and a channel through which the gear moves; and a gate positioned adjacent the toothed gear configured to allow only one bean to pass from a bean storage area to each of the plurality of pockets.

3. The apparatus of Embodiment 1, wherein the bean delivery device comprises a controller configured to operate the bean delivery device in a first mode and a second mode, wherein the second mode is slower than the first mode.

4. The apparatus of Embodiment 3, wherein the bean delivery device is operated at the first and second mode based on real-time feedback provided from the weighing device to the controller.

5. The apparatus of Embodiment 1, wherein the bean delivery device comprises a controller configured to run a calibration cycle to determine the average weight or mass per bean, a user interface for inputting a desired weight or mass, and a counter configured to provide real-time feedback for delivering a count of coffee beans corresponding to the desired weight or mass calculated from the average weight or mass per bean.

6. A method of dispensing coffee beans comprising: measuring a weight or mass of delivered coffee beans with a weighing device; providing automated feedback from the measurement of the weighing device to a controller of a bean delivery device; delivering coffee beans by using the feedback and the bean delivery device with single-bean precision to a coffee bean receptacle.

7. The method of Embodiment 6, wherein delivering comprises: rotating a toothed gear comprising a plurality of pockets each configured to accommodate and transport one coffee bean, wherein each of the plurality of pockets is formed by the distance between two adjacent teeth of the toothed gear and a channel through which the gear moves, wherein each of the plurality of pockets is sized to accommodate no more than one coffee bean.

8. The apparatus of Embodiment 6, wherein the controller operates the bean delivery device in a first mode and a second mode, wherein the second mode is slower than the first mode.

9. The apparatus of Embodiment 8, wherein delivering in the first mode and the second mode is based on real-time feedback provided from the weighing device to the controller.

10. The apparatus of Embodiment 6, wherein using the feedback comprises running a calibration cycle with a controller to determine the average weight or mass per bean, and wherein delivering comprises using a counter to provide real-time feedback for delivering a count of coffee beans corresponding to a desired weight or mass calculated from the average weight or mass per bean.

1. A device for precise coffee bean dispensing comprising:
a coffee bean hopper, an internal dispensing mechanism, an electronic weighing receptacle, and a printed circuit board or other electronic component, wherein the coffee from the hopper is incrementally dispensed into the weighing receptacle, and an automated feedback loop controlled by the circuit board stops the coffee bean dispensation at the desired weight set by the user.

2. The device of claim 1, wherein the internal dispensing mechanism is a toothed gear turned by a motor with sufficient rotational control to permit tooth-by-tooth precision of turning, and the gear teeth sized such that coffee beans pass through one at a time.

3. The toothed gear mechanism of claim 2, wherein the excess coffee beans are retained by a spring-loaded or other compliant flap such that beans are dispensed one at a time into the electronic weighing receptacle.

4. The device of claim 1, wherein the internal dispensing mechanism is a conveyor-belt platform with bean retention walls that allow beans to be dispensed one at a time into the electronic weighing receptacle.

5. The device of claim 1, wherein there is an internal electronic feedback loop between the weighing receptacle and the internal dispensing mechanism (e.g. toothed gear mechanism of claim 2 or conveyor belt of claim 4), such that coffee beans can be dispensed up to the desired input weight (or mass) without dispensing beyond the desired weight.

6. The device of claim 1, wherein the user interface allows incremental increasing or decreasing by 0.1 grams or less, and this user set weight (or mass) is then used by the electronic feedback loop between the weighing receptacle and the dispensing mechanism of claims 2 and 4.

7. The device of claim 1, wherein the weighing receptacle is comprised of a receptacle mounted upon a load cell.

8. The device of claim 1, wherein the weighing receptacle is comprised of a receptacle mounted upon a strain gauge.

9. The toothed gear mechanism of claim 2, wherein the gear is rotated by a stepper motor.

10. The toothed gear mechanism of claim 2, wherein the gear is rotated by a brushless DC motor.

11. The device of claim 1, wherein the weighing receptacle of claims 7 and 8 is emptied by rotating the entire receptacle until the beans fall out to an exit chute beneath.

12. The device of claim 1, wherein the weighing receptacle of claims 7 and 8 is emptied by pressing a lever that opens a trap door mechanism allowing the beans to fall out an exit chute beneath.

13. The electronic feedback loop of claim 6, wherein the feedback loop reduces the motor speed and therefore dispensing rate to prevent dispensing beyond the desired weight while optimizing dispensation time.

14. The electronic feedback loop of claim 6, wherein the feedback loop calculates the feed rate in a pre-determined amount of time, and then uses a multiplication factor of this time to dispense the user input weight.

15. The electronic feedback loop of claim 6, wherein the feedback loop calculates the feed rate in a pre-determined number of gear rotations, and then uses a multiplication factor of these rotations to dispense the user input weight.

16. The electronic feedback loop of claim 6, wherein the feedback loop temporarily stops the motor while the weighing receptacle takes a measurement and stops the cycle if the input weight has been reached, or moves the motor to dispense another bean into the weighing receptacle to repeat the process.
